(19) United States
(12) Patent Application Publication
(10) Pub. No.: US 2007/0277991 A1
(43) Pub. Date: Dec. 6, 2007

(54) Percussion Device

(76) Inventors: Kurt Andersson, Tyreso (SE); Jorgen Rodert, Saltsjo-Boo (SE)

Correspondence Address: Mark P.Stone, 25 Third Street, 4th Floor, Stamford, CT, 06905, US

(21) Appl. No.: 11/663,016

(22) PCT Filed: Sep. 28, 2005
(86) PCT No.: PCT/SE05/01425

§ 371 Date: Mar. 15, 2007

(30) Foreign Application Priority Data
Oct. 14, 2004 (SE) 0402482-4

(51) Int. Cl. B25D 9/14

(52) U.S. Cl. 173/207

(57) ABSTRACT

Percussion device including a machine housing (1),′ a forwards and backwards movable percussion piston (2) in the machine housing, and a reciprocatingly movable valve body (6) in the machine housing, said percussion piston (2) being arranged to, subject a tool (3)′ to impacts, and said percussion piston including a first (4) and a second (5) driving surface intended to be subjected to pressure in order to drive the percussion piston (2), forwards and backwards, said valve body ** (6) including a first end surface (12) and a second end surface (13), wherein the pressurizing of the first end surface (12) tends to drive the valve body in a first direction and pressurizing of the second end surface (13), tends to drive the valve body in a second direction, whereby the valve body (6) is arranged, over a channel (7) arranged in the machine housing, to connect at least the second (5) of the driving surfaces alternately to a pressure source (8) or to low pressure (9), wherein the second end surface (13), by the percussion piston (2), is alternately connectable to the pressure source (8) or, over a valve device (11) for creating a counter-pressure, to the low pressure (8).

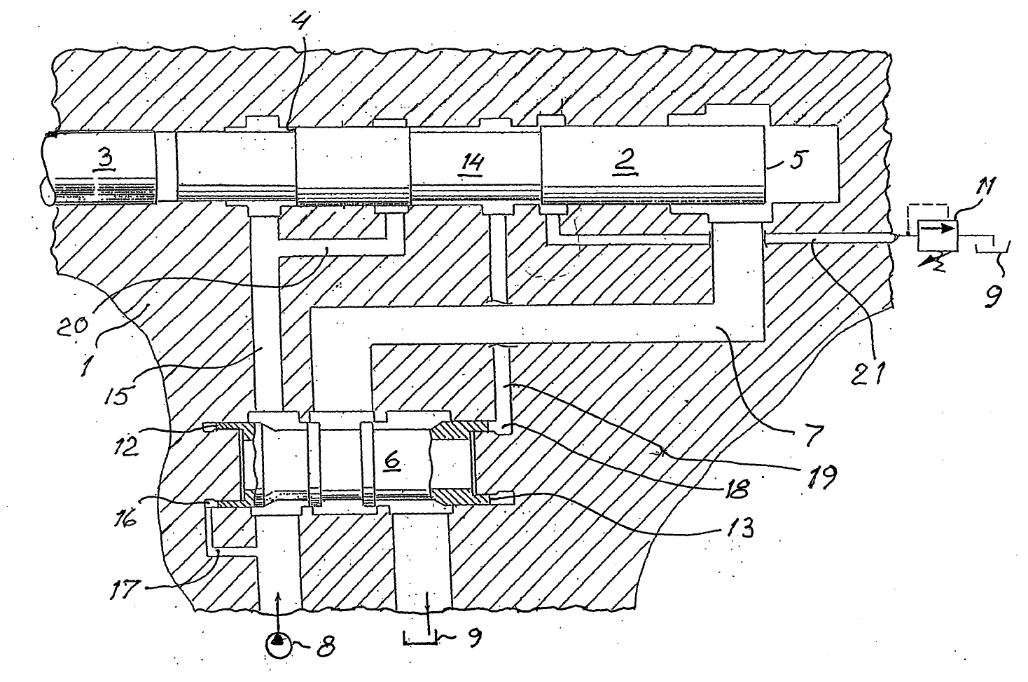

The present invention relates to a percussion device of the type that is included in rock drilling machines.

In a previously known percussion device of this kind, see U.S. Pat. No. 5,372,196, it has been proved to be difficult to obtain sufficiently fast valve change-over in order to work at the high frequencies that are desired in modern high performance drilling. An essential explanation thereto is that an important portion of the liquid which is located in front of the valve body at the return of the valve body continues because of inertia. Because of this a refill must take place in order to build up the pressure before the valve body starts to move in the opposite direction.

The present invention as defined in the following claims, aims at creating a percussion device with fast valve change over which is suitable for high performance drilling.

An embodiment of the invention is described below with reference to the annexed drawing which schematically shows a section through a percussion device according to the invention.

The percussion device shown on the drawing includes a machine housing 1, wherein a percussion piston 2 is reciprocatingly movable in order to subject a tool 3 to impacts. The tool is as usual provided with a here not shown drill bit. The percussion piston is provided with a first driving surface 4 which in the shown example is continuously pressurized by a pressure source 8 over a channel 15. The percussion piston is further provided with a second driving surface 5 which in the shown example is comprised of the rear surface of the percussion piston. The driving surface 5 is alternately connected to the pressure source 8 or to the low pressure of the tank 9 over channel 7 and a valve body 6 which is movable forwards and backwards in the machine housing. As an alternative the valve body could connect both driving surfaces alternately to the pressure source or low pressure. In the shown example, the pressurizing of the first driving surface 4 drives the percussion piston to the right in the FIGURE. Since the area of the second driving surface 5 is essentially larger than the area of the first driving surface 4, pressurizing of the driving surface 5 results in that the percussion piston is driven to the left in the FIGURE, against the effect of the pressure on the driving surface 4. The valve body 6 is constructed as a tubular slide with a first end surface 12 which is subjected for the pressure in a first chamber 16. The chamber 16 is over the channel 17 connected to the pressure source 8. The valve body 6 is further provided with a second end surface 13 which is subjected to the pressure in a second chamber 18. The chamber 18 is over the channel 19 connected to the cylinder bore of the percussion piston 2. The pressure in the channel 19 is controlled by the percussion piston 2 which is provided with a portion 14 having a reduced diameter. When the percussion piston 2 is positioned somewhat to the left of the position in the FIGURE, the channel 19 is in connection with the pressure source 8 over the channels 15 and 20. The valve body 6 is then pressed to the left in the FIGURE. When the percussion piston 2 reaches the position shown in the FIGURE, the connection of the channel 19 with the pressure source 8 has been broken and a connection with the channel 21 started to open. In the channel 21 there is positioned a constant pressure valve 11. Its function is to give a constant fall off pressure independent of the flow through the valve. It is thus a valve device for creating a counter-pressure. Hereby the amount of liquid leaving the channel 19 when the valve body 6 changes direction in its right position in the FIGURE is essentially reduced, whereby the change-over goes essentially faster.

1. Percussion device including a machine housing, a forwards and backwards movable percussion piston in the machine housing, and a reciprocatingly movable valve body in the machine housing, said percussion piston being adapted to subject a tool to impacts, and said percussion piston including a first and a second driving surface intended to be subjected to pressure in order to drive the percussion piston forwards and backwards, said valve body including a first end surface and a second end surface, wherein the pressurizing of the first end surface tends to drive the valve body in a first direction and pressurizing of the second end surface tends to drive the valve body in a second direction, whereby the valve body is arranged, over a channel arranged in the machine housing, to connect at least the second of the driving surfaces alternately to a pressure source or to low pressure, wherein the second end surface, by the percussion piston, is alternately connectable to the pressure source or, over a valve device for creating a counter pressure, to the low pressure.

2. Percussion device according to claim 1, wherein the first driving surface is continuously connected to the pressure source.

3. Percussion device according to claim 1, wherein the first end surface is continuously connected to the pressure source.

4. Percussion device according to claim 2, wherein the first end surface is continuously connected to the pressure source.
